(19) United States
(12) Patent Application Publication
(10) Pub. No.: US 2018/0297279 A1
(43) Pub. Date: Oct. 18, 2018

(54) A THREE-DIMENSIONAL IMAGING APPARATUS FOR MODELING A COLORED THREE-DIMENSIONAL OBJECT

(71) Applicant: MAGICFIRM EUROPE AB, Gothenburg (SE)

(72) Inventor: Mats MOOSBERG, Torslanda (SE)

(73) Assignee: MAGICFIRM EUROPE AB, Gothenburg (SE)

(21) Appl. No.: 15/568,092

(22) PCT Filed: Jun. 2, 2016
(86) PCT No.: PCT/SE2016/000031

§ 371 Date: Oct. 20, 2017

(30) Foreign Application Priority Data
Apr. 22, 2015 (SE) 1500198-5

(51) Int. Cl. B29C 64/209; B33Y 30/00; B29C 64/227; B29C 64/295; B33Y 70/00

(52) U.S. Cl. CPC B29C 64/209; B33Y 30/00; B29K 2105/0032; B29C 64/295; B33Y 70/00; B29C 64/227

(57) ABSTRACT

The present invention relates to a three-dimensional imaging apparatus for modeling a colored three-dimensional object on a layer-by-layer basis in accordance with a computer aided design (CAD) image of the object. The apparatus includes a printhead unit comprising a melting chamber; a primary feeding channel arranged between a supply of primary modeling material in solid state, preferably in filament form, and the melting chamber; driving means to drive and regulate the flow of the primary modeling material through the primary feeding channel toward the melting chamber; secondary feeding channels each of which is arranged between a supply of colorant material in solid state, preferably in filament form and the melting chamber; driving means to drive and regulate the flow of the solid colorant materials in accordance with a predetermined computer generated coloring pattern to the melting chamber; heating means arranged adjacent to the melting chamber for supplying heat energy inside the melting chamber for converting the primary modeling material and the colorant materials therein from a solid state to a flowable fluid state to obtain a colored modeling material; a dispensing nozzle through which the colored modeling material in flowable fluid state is conveyed from the melting chamber to an object supporting platform positioned at a predetermined distance from the dispensing nozzle and motion devices coupled to said platform and said nozzle for moving said nozzle and said platform relative to one another in a plane defined by first and second directions and in a third direction orthogonal to said plane to deposit said flowable fluid material into a three-dimensional object.

The present invention relates to a computer-controlled object-modeling apparatus for depositing colored objects on a layer-by-layer basis under the control of a data processing system.

### BACKGROUND OF THE INVENTION

With the increased use of Computer Aided Design (CAD) solid modeling systems a new frontier of manufacturing technology has emerged that enables translation of the CAD output data into a three-dimensional (3-D) physical object. This technology is commonly referred to as solid freeform fabrication (SFF) or layer manufacturing, which entails building an object on a layer-by-layer and point-by-point basis.

A commercially available system, fused filament fabrication (FFF), uses a heated nozzle to extrude a melted material such as a plastic wire. The starting material is in the form of a filament being supplied from a spool. The filament is introduced into a flow passage of the nozzle and is driven to move like a piston inside this flow passage. The front end, near the nozzle tip, of this piston is heated to become melted; the rear end or solid portion of this piston pushes the melted portion forward to exit through the nozzle tip. The nozzle is translated under the control of a computer system in accordance with previously generated CAD data sliced into constituent layers. The FFF technique was first disclosed in U.S. Pat. No. 5,121,329 (1992), entitled “Apparatus and Method for Creating Three-Dimensional Objects,” issued to S. S. Crump. The primary applications of this FFF technique have been the fabrication of prototypes and the creation of positive forms to be utilized in investment casting processes. The users of the FFF technology have heretofore been concerned primarily with the dimensional accuracy and surface finish of the final part. Little attention has been paid to the formation of a color pattern on the surface or inside the body of the final part.

Another fused filament fabrication apparatus is disclosed in U.S. Pat. No. 6,129,872 entitled “Computer controlled object-building process and apparatus for depositing colorful objects on a layer-by-layer basis under the control of a data processing system” issued to Justin Jang. According to this patent, a three-dimensional printing apparatus includes a supply of filament material; a filament-feeding device comprising one filament feeding channel and drive means such as motors to drive and regulate the flow of the filament in the feeding channel; a dispensing nozzle having a flow passage communicating with this feeding channel to receive the filament therefrom, heating means for converting a leading portion of the filament to a flowable fluid state, and a discharge orifice to dispense the fluid therethrough. The apparatus further includes an object-supporting platform in close, working proximity to the discharge orifice to receive the fluid discharged therefrom; and motion devices coupled to the platform and the nozzle for moving the nozzle and the platform relative to one another in an X-Y plane and in a third direction (Z direction) orthogonal to the X-Y plane to deposit the fluid into a three-dimensional object.

The apparatus further includes a multi-channel colorant-injecting module comprising an injecting channel in flow communication with the flow passage of the nozzle, a reservoir for a colorant in flow communication with the injecting channel, and valve means in control relation to the injecting channel to regulate the flow of the colorant therefrom; the injecting channel directing the colorant to mix with a leading portion of the filament material for forming a colorant-containing fluid.

A drawback of such an apparatus is that the colorant-injecting channels have to be located in the immediate vicinity of the discharge orifice in order to permit a fast change-over from one color to another. If a colorant is introduced way upstream from the discharge orifice, then it will take some time for a fluid containing this colorant to be completely discharged. This will delay the step of switching over to another color and prolong the transition period of time during which mixing of colorants takes place. In such a design, a change-over from one color to another will not be easily accomplished and will take an excessively long time to complete, allowing undesirable mixing of colorants to occur inside the channel before being discharged from the orifice.

There is still a need for a printhead structure that enables higher color resolution in a three-dimensional object.

### SUMMARY OF THE INVENTION

The foregoing and other problems are overcome and the objects of the invention are realized by using an apparatus for fabricating a colored three-dimensional object in accordance with a CAD-generated image of the object and under the control of a computer.

As a first embodiment of the present invention a three-dimensional imaging apparatus for modeling a colored three-dimensional object on a layer-by-layer basis in accordance with a computer aided design (CAD) image of the object. The apparatus includes a printhead unit comprising a melting chamber; a primary feeding channel arranged between a supply of primary modeling material in solid state, preferably in filament form, and the melting chamber; driving means to drive and regulate the flow of the primary modeling material through the primary feeding channel toward the melting chamber; secondary feeding channels each of which is arranged between a supply of colorant material in solid state, preferably in filament form and the melting chamber; driving means to drive and regulate the flow of the solid colorant materials in accordance with a predetermined computer generated coloring pattern to the melting chamber; heating means arranged adjacent to the melting chamber for supplying heat energy inside the melting chamber for converting the primary modeling material and the colorant materials therein from a solid state to a flowable fluid state to obtain a colored modeling material; a dispensing nozzle through which the colored modeling material in flowable fluid state is conveyed from the melting chamber to an object supporting platform positioned at a predetermined distance from the dispensing nozzle and motion devices coupled to said platform and said nozzle for moving said nozzle and said platform relative to one another in a plane defined by first and second directions and in a third direction orthogonal to said plane to deposit said flowable fluid material into a three-dimensional object.

The primary modeling material may be comprised of, but is not limited to, one or more of the following materials including various waxes, thermoplastic polymers, thermoset polymers, metallic alloys, glasses, ceramics, and combinations thereof. The material may also include combinations containing dissimilar materials added to impart a desired electrical, structural, or other functional characteristic to the material. However, the primary modeling material preferably comprises an organic polymer with a reasonably low softening or melting point, e.g., acrylonitrile-butadiene-styrene (ABS) or Polylactic acid (PLA). Preferably, the primary modeling material is made of ABS or PLA material without pigment additives to form a colorless transparent ground into which the colorant materials can be mixed inside the melting chamber.

The colorant material may be a pigment or color concentrate (commonly used in coloring of plastics) preferably in filament form. High concentrate pigment material allows quick color changes. Advantageously, a first colorant filament is made of a Cyan pigment, a second colorant filament is made of a Magenta pigment, a third colorant filament is made of a Yellow pigment and a fourth pigment filament is made of a Black pigment in order to obtain a color scale in accordance with CMYK color systems.

In a preferred embodiment of the present invention, a printhead structure includes four different secondary feeding channels each of which corresponding to a specific colorant material in filament form. The colorant material filament feeds from a supply (e.g. a filament spool) through an upper inlet aperture of a corresponding secondary feeding channel, to be conveyed through said channel toward the melting chamber by corresponding driving means. An example of driving means comprises a plurality of drive rollers driven simultaneously by a stepper motor. A plurality of idler rollers located opposite to drive rollers may work together therewith to grip the filament therebetween and to advance it through a corresponding secondary feeding channel toward the melting chamber.

The melting chamber is disposed in close proximity to the primary filament feeding channel and to the four secondary filament feeding channels. The melting chamber has a flow passage communicating with each feeding channel through lower apertures of the chamber to receive the filament materials therefrom. Heating means (in the form of a resistance heating tape or sleeve) is positioned around the lower portion of the melting chamber for supplying heat energy inside the melting chamber for converting a leading portion of the modeling filament material and a leading portion of the colorant filament materials to a flowable fluid state. The solid (un-melted) portion of the filaments inside the feeding channels acts like pistons to drive the melted liquid into the melting chamber wherein the modeling material and the colorant materials are mixed to obtain a colored fluid in accordance with a predetermined color pattern. The drive motors can be controlled to regulate the advancing rate of the colorant filaments in the secondary feeding channels so that the volumetric dispensing rate of the fluid can be closely controlled in accordance with the color pattern.

### BRIEF DESCRIPTION OF THE DRAWINGS

FIG. 1 is a schematic cross section view of an apparatus in accordance with the present invention

### DESCRIPTION OF A PREFERRED EMBODIMENT

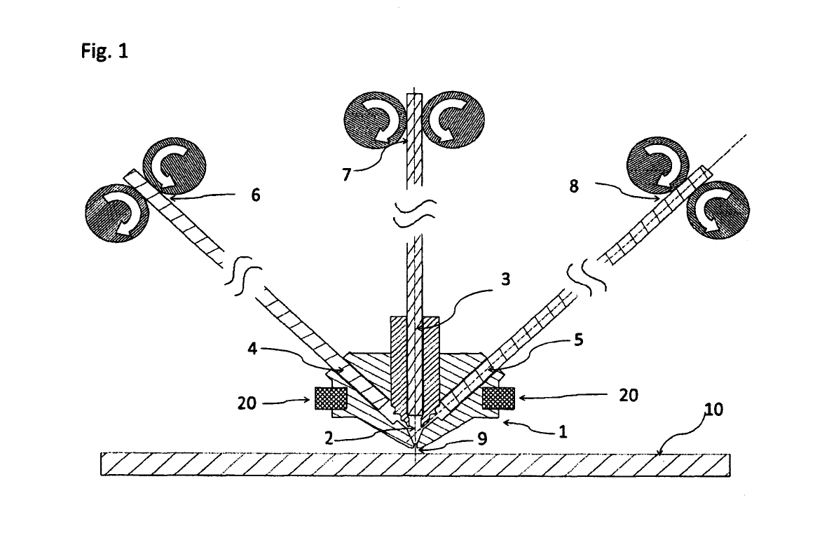

As schematically shown in FIG. 1, a preferred embodiment of the present invention includes a printhead unit having a nozzle block 1 preferably made of a material with a thermal conductivity greater than 25 W/(m·K), such as, for example, brass or similar metallic alloys. The nozzle block 1 encloses a melting chamber 2 which can be heated to a temperature sufficiently high for the filaments to liquefy. The melting chamber 2 is surrounded by heater elements 20 and a temperature sensor that regulate the temperature inside the melting chamber 2 to a temperature of approximately 200° C. to 240° C. The printhead unit is further provided with a plurality of feeding channels 3,4,5. A first primary feeding channel 3 is arranged between a supply of primary modeling material, preferably in filament form, and the melting chamber 2. Secondary feeding channels 4,5 are arranged in the nozzle block 1 for conveying the color filaments from the color filament supplies to the melting chamber 2. Drive means 6, 7, 8 are arranged in connection with each channel to drive the filaments inside the channels toward the melting chamber 2. An example of drive means comprises a plurality of drive rollers connected to one another by a suitable belt or chain drive and driven simultaneously by a stepper motor and a drive belt or chain. A plurality of idler rollers located opposite to drive rollers may work together therewith to grip the filament therebetween and to advance it toward the melting chamber 2 and therefrom to the dispensing nozzle 9.

The dispensing nozzle 9 is disposed in close proximity to the filament feeding channels 3, 4, 5. The nozzle 9 is shown to be intimately connected to melting chamber 2 and the filament-feeding channels 3,4, 5. The nozzle has a flow passage communicating with the feeding channel through a lower aperture of the chamber to receive the filament material therefrom. Heater elements 20 (in the form of a resistance heating tape or sleeve) are positioned around the lower portion of the melting chamber 2 for converting a leading portion of the filament material to a flowable fluid state. The solid (un-melted) portion of the filaments inside the feeding channels 3, 4, 5 act like pistons to drive the melted liquid for dispensing through a discharge orifice. The drive motor 6, 7, 8 can be controlled to regulate the advancing rate of the filament in the feeding channel 3, 4, 5 so that the volumetric dispensing rate of the fluid can be closely controlled.

A plurality of colorant feeding channels 4,5 are disposed in the vicinity of the melting chamber 2. Only two of the channels are shown, as an example, in FIG. 1. The nozzle block 1 comprises two colorant channels 4,5 in flow communication with the melting chamber 2, for conveying the colorant filament materials from colorant filament supplies to the melting chamber 2. Driving means are arranged in connection to each colorant channel to regulate the flow of colorant filament in accordance with a predetermined color pattern of the object. As the colorant filament is conveyed inside the melting chamber, it is converted from a solid state to a flowable fluid state and is thereby mixed together with the modeling material in order to form a colored fluid material which can be deposited through the dispensing nozzle.

Referring again to FIG. 1, the object platform 10 is located in close, working proximity to the dispensing nozzle. The upper surface of the platform preferably has a flat region sufficiently large to accommodate the first few layers of the deposited material. The platform and the nozzle are equipped with mechanical drive means for moving the platform relative to the dispensing nozzle in three dimensions along the X-, Y-, and Z-axes in a rectangular coordinate system in a predetermined sequence and pattern, and for displacing the nozzle a predetermined incremental distance relative to the platform. This can be accomplished, for instance, by allowing the platform to be driven by three linear motion devices, which are powered by three stepper motors to provide movements along the X-, Y-, and Z-directions, respectively. Motor means are preferably high resolution reversible stepper motors, although other types of drive motors may be used, including linear motors, servomotors, synchronous motors, D.C. motors, and fluid motors. Mechanical drive means including linear motion devices, motors, and gantry type positioning stages are well known in the art.

Z-axis movements are effected to displace the platform relative to the nozzle or to displace the nozzle relative to the platform and, hence, relative to each layer deposited prior to the start of the formation of each successive layer. In one possible arrangement, the nozzle and other hardware attached to the nozzle may be mounted in a known fashion for movement in the X-Y plane, with the platform supported for separate movement toward and away from the nozzle along the Z-direction. Alternatively, the platform may be supported for movement in the X-Y plane, with the nozzle mounted for separate movement along the Z-direction toward and away from the platform. Another alternative is to have the movements in the X-Y plane and in the Z-direction all to be carried out by either the platform only or by the nozzle only. It will be understood that movement in the X-Y plane need not be limited to movement in orthogonal directions, but may include movement in radial, tangential, arcuate and other directions in the X-Y plane.

1. A three-dimensional imaging apparatus for modeling a colored three-dimensional object on a layer-by-layer basis in accordance with a computer aided design (CAD) image of said object, comprising:
a supply of primary modeling material in solid state;
an object supporting platform
a printhead unit including a melting chamber; a primary feeding channel arranged between said supply of primary modeling material and said melting chamber; drive means to drive and regulate the flow of said primary modeling material through said primary feeding channel toward said melting chamber;
heating means arranged adjacent to said melting chamber for supplying heat energy inside said melting chamber for converting said primary modeling material therein from a solid state to a flowable fluid state; a dispensing nozzle for conveying said flowable fluid material from said melting chamber to said object supporting platform;
motion devices coupled to said platform and said nozzle for moving said nozzle and said platform relative to one another in a plane defined by first and second directions and in a third direction orthogonal to said plane to deposit said flowable fluid material into a three-dimensional object.
wherein said apparatus further includes
at least one supply of colorant material in solid state
at least one secondary feeding channel arranged in said printhead unit between said at least one supply of colorant material in solid state and said melting chamber; and
drive means to drive and regulate the flow of said solid colorant material in accordance with a predetermined coloring pattern to said melting chamber in which said colorant material is converted from a solid state to a flowable fluid state and thereby mixed with said primary modeling material to obtain a colored modeling material.

2. A three-dimensional imaging apparatus as claimed in claim 1 wherein said solid colorant material is in filament form.

3. A three-dimensional imaging apparatus as claimed in claim 1 wherein said printhead unit comprises four secondary feeding channels each of which is coupled to one specific supply of colorant material.

4. A three-dimensional imaging apparatus as claimed in claim 1 wherein the modeling material consists of plastic material without pigment additives

5. A three-dimensional imaging apparatus as claimed in claim 1 wherein the modeling material consists of plastic material with white pigment additives

6. A three-dimensional imaging apparatus as claimed in claim 1 wherein the colorant material consists of plastic color concentrates.

7. A three-dimensional imaging apparatus as claimed in claim 1 wherein the colorant materials consist of cyan, magenta, yellow and black color concentrates in accordance with the CMYK color system.

8. A three-dimensional imaging apparatus as claimed in claim 1 wherein the secondary feeding channels communicate with the melting chamber through apertures that are smaller than the aperture of the primary feeding channel.

9. A three-dimensional imaging apparatus as claimed in claim 1 wherein the secondary feeding channels communicate with the melting chamber through apertures that distribute the colorant materials at the outline of the dispensing nozzle.
